(19) United States
(12) Patent Application Publication
(10) Pub. No.: US 2024/0094995 A1
(43) Pub. Date: Mar. 21, 2024

(54) GENERATING SURROGATE PROGRAMS USING ACTIVE LEARNING

(71) Applicant: INTERNATIONAL BUSINESS MACHINES CORPORATION, Armonk, NY (US)

(72) Inventors: Swagatam Haldar, Kolkata (IN); Devika Sondhi, New Delhi (IN); Diptikalyan Saha, Bangalore (IN)

(21) Appl. No.: 17/948,625

(22) Filed: Sep. 20, 2022

(51) Int. Cl. G06F 8/35; G06F 9/54

(52) U.S. Cl. CPC G06F 8/35; G06F 9/54

(57) ABSTRACT

A method of providing a surrogate program for a program endpoint includes: obtaining, by a processor set, a set of plural input/output pairs generated using the program endpoint; generating, by the processor set, transformations based on the input/output pairs; generating, by the processor set, a model that classifies inputs of the input/output pairs to ones of the transformations based on parameters of one or more strings of the inputs; receiving, by the processor set, a new input; selecting, by the processor set and using the model, one of the transformations based on parameters of one or more strings of the new input; and generating, by the processor set, a new output by applying the selected one of the transformations to the new input.

### BACKGROUND

Aspects of the present invention relate generally to generating surrogate computer programs and, more particularly, to generating surrogate programs using active learning.

In computer science, programming by example, also termed programming by demonstration or more generally as demonstrational programming, is an end-user development technique for teaching a computer new behavior by demonstrating actions on concrete examples. The system records user actions and infers a generalized program that can be used on new examples.

### SUMMARY

In a first aspect of the invention, there is a method of providing a surrogate program for a program endpoint, the method including: obtaining, by a processor set, a set of plural input/output pairs generated using the program endpoint; generating, by the processor set, transformations based on the input/output pairs; generating, by the processor set, a model that classifies inputs of the input/output pairs to ones of the transformations based on parameters of one or more strings of the inputs; receiving, by the processor set, a new input; selecting, by the processor set and using the model, one of the transformations based on parameters of one or more strings of the new input; and generating, by the processor set, a new output by applying the selected one of the transformations to the new input.

In another aspect of the invention, there is a computer program product comprising one or more computer readable storage media having program instructions collectively stored on the one or more computer readable storage media. The program instructions are executable to: obtain a set of plural input/output pairs generated using a program endpoint; generate transformations based on the input/output pairs; generate a model that classifies inputs of the input/output pairs to ones of the transformations, wherein the model comprises an interpretable model; receive a new input; select, using the model, one of the transformations based on parameters of one or more strings of the new input; and generate a new output by applying the selected one of the transformations to the new input.

In another aspect of the invention, there is system including a processor set, one or more computer readable storage media, and program instructions collectively stored on the one or more computer readable storage media. The program instructions are executable to: obtain a set of plural input/output pairs generated using a program endpoint; generate transformations based on the input/output pairs; generate a model that classifies inputs of the input/output pairs to ones of the transformations, wherein the model comprises an interpretable model; receive a new input; select, using the model, one of the transformations based on parameters of one or more strings of the new input; and generate a new output by applying the selected one of the transformations to the new input.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIGS. 3A, 3B, 3C, and 3D show examples of a program endpoint, input/output pairs, and an interpretable model in accordance with aspects of the invention.

FIGS. 4A and 4B show examples of an interpretable model in accordance with aspects of the invention.

FIG. 5 shows a functional block diagram in accordance with aspects of the invention.

FIG. 6 shows examples of input/output pairs and transformations in accordance with aspects of the invention.

FIG. 7 shows an example of path learning in accordance with aspects of the invention.

FIG. 8 shows an exemplary pseudocode for a recursive path learning algorithm in accordance with aspects of the invention.

FIG. 9 shows a flowchart of an exemplary method in accordance with aspects of the invention.

### DETAILED DESCRIPTION

Aspects of the present invention relate generally to generating surrogate computer programs and, more particularly, to generating surrogate programs using active learning. Implementations of the invention generate a surrogate program that replicates the function of a program endpoint without knowing or having access to the code of the program endpoint. According to aspects of the invention, the program endpoint receives string inputs and generates string outputs based on the string inputs. Embodiments use transformation learning to generate a set of plural transformations based on a sample set of plural input/output pairs generated using the program endpoint. Embodiments use path learning to generate a model that classifies the inputs to the generated transformations. Embodiments additionally use active learning to refine the model based on further interactions with the program endpoint. In accordance with aspects of the invention, the model is an interpretable model. In one example, the model comprises a decision tree-based model in which paths of the tree are interpretable and can be treated as path constraints. In this manner, implementations of the invention may be used to create a surrogate program that replicates the function of a program endpoint, where the surrogate program includes an interpretable model.

In an embodiment, the program endpoint is an application programming interface (API) endpoint having string input variables and string output variables. The API endpoint has an executable interface, and a set of plural input/output pairs may be generated using the API endpoint via the executable interface. In this embodiment, a system or method in accordance with aspects of the invention generates an interpretable surrogate program by learning a model that approximates the functioning of the API endpoint. The model is interpretable in the sense that it explicitly represents the execution paths and computations happening inside the API endpoint. In accordance with aspects of the invention, a modified decision tree-based algorithm is used to learn a decision tree model in which the paths of the decision tree are readily interpretable as execution paths. The modifications include: a new set of constraints to handle/partition string input variables; a grammar of transformations to represent the computations happening in the leaf (terminal) nodes; and a component to generate more inputs during the building process and query the available interface to fetch the outputs. In this manner, implementations of the invention generate a decision tree with a grammar to represent computations/transformations happening in the leaf nodes. The decision tree includes a set of constraints (e.g., string length, substring etc.) to handle string input variables. Embodiments iteratively query the API endpoint by incrementally generating samples during the tree building process to improve fidelity of the surrogate program. The generated surrogate program may be used for test case generation for the API endpoint as it explores different execution paths. Moreover, because the learned surrogate program gives an input-output relationship of the API endpoint, the surrogate program can also be used for symbolic execution of API endpoints whose code is not available.

Conventional programming approximation technologies do not produce an interpretable result. For example, symbolic search-based program synthesis techniques (such as Flash Fill and Blink Fill) search for a program in a domain specific language (DSL) with sample input/output. Neural guided search techniques (such as Deep Coder and Neural Guided Deductive Search (NGDS), and PROSE) guide the search over tokens from a DSL using a neural architecture. Statistical program synthesis techniques (such as Robust Fill) learn probability distribution over linearized, pre-defined program tokens, with no control flow. These techniques are program synthesis approaches and, in general, they do not assume the availability or even existence of the target program they are trying to synthesize/learn. Moreover, the information in the synthesized program is limited by the DSL.

Other techniques, such as neural program induction techniques (such as neural Turing machines), directly train a neural network model to map inputs to outputs without any program representation. However, the underlying model is not interpretable and provides no under-the-hood knowledge about the program. These conventional techniques thus generate an opaque box transformation that receives an input and generates an output, but without providing any interpretability of how the transformation arrives at the output.

Implementations of the invention address the above-described problems by generating a surrogate program that replicates the functioning of a program endpoint, the surrogate program comprising an interpretable model. Implementations of the invention generate a surrogate program that does not previously exist, and this program can then be used for activities such as API testing, symbolic execution, and artificial intelligence operations (AIOps). The interpretable nature of the model provides a benefit over conventional opaque box transformation techniques because the constraints and paths of an interpretable model can be analyzed to produce more extensive test cases. Implementations of the invention thus have a practical application because they provide an improvement in the technical field of generating surrogate computer programs.

For example, in API testing, a surrogate program generated in accordance with aspects of the invention may be used for generating test cases for APIs in which the source code of the API is withheld (i.e., unknown). In this context, a surrogate program according to the present disclosure has better coverage than programs created using conventional techniques. This is because a surrogate program according to the present disclosure provides the tester with a better understanding of the API in terms of execution paths of the API that are learned by the surrogate program. This added program behavior information on the inputs of the API can help navigate the generation of a test suite with higher coverage of paths. It can also help find unexplored paths in the program, such as in failure driven test cases.

In another example, a surrogate program according to the present disclosure may be used for symbolic execution of uninterpreted functions. Conventional techniques for symbolic execution assume nothing about uninterpreted functions (i.e., a function specifying only its signature and arity) apart from the function assumption (i.e., same output on same input). Conventional techniques for symbolic execution thus approximate uninterpreted functions as functions returning a single value (i.e., constant function), completely losing any possible path relation between the return value and the function's inputs. In contrast to conventional techniques, a surrogate program according to the present disclosure is usable to infer input-output dependencies for such cases, and these dependencies can be used to analyze such applications.

In another example, a surrogate program according to the present disclosure may be used in AIOps to find representative test cases. In this context, implementations of the invention may generate a surrogate program for an API with workload data and then obtain representative test cases from the paths in the surrogate program.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as surrogate program generation code represented by block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

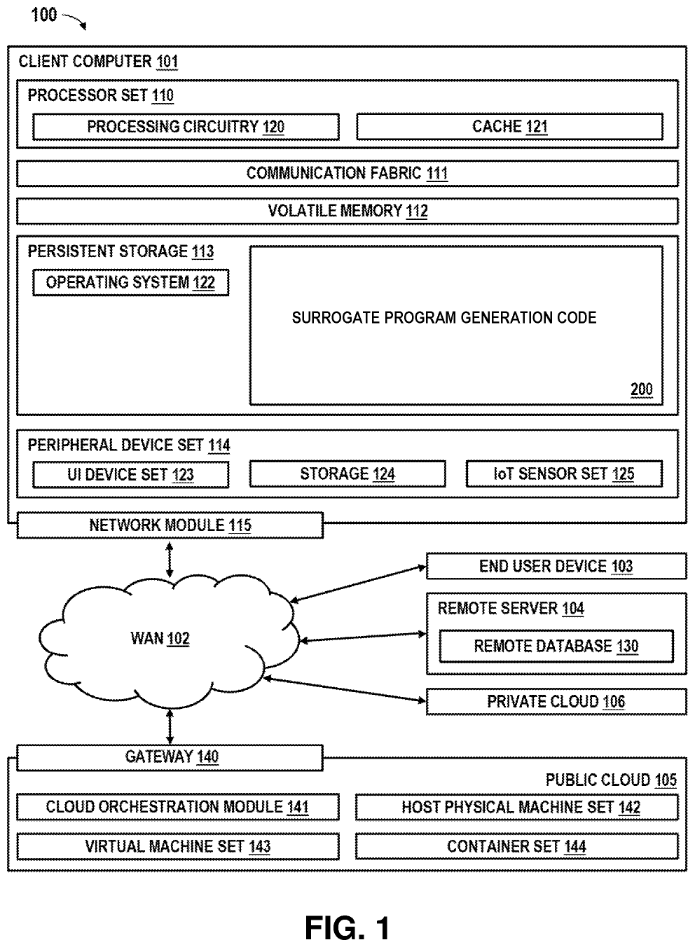

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

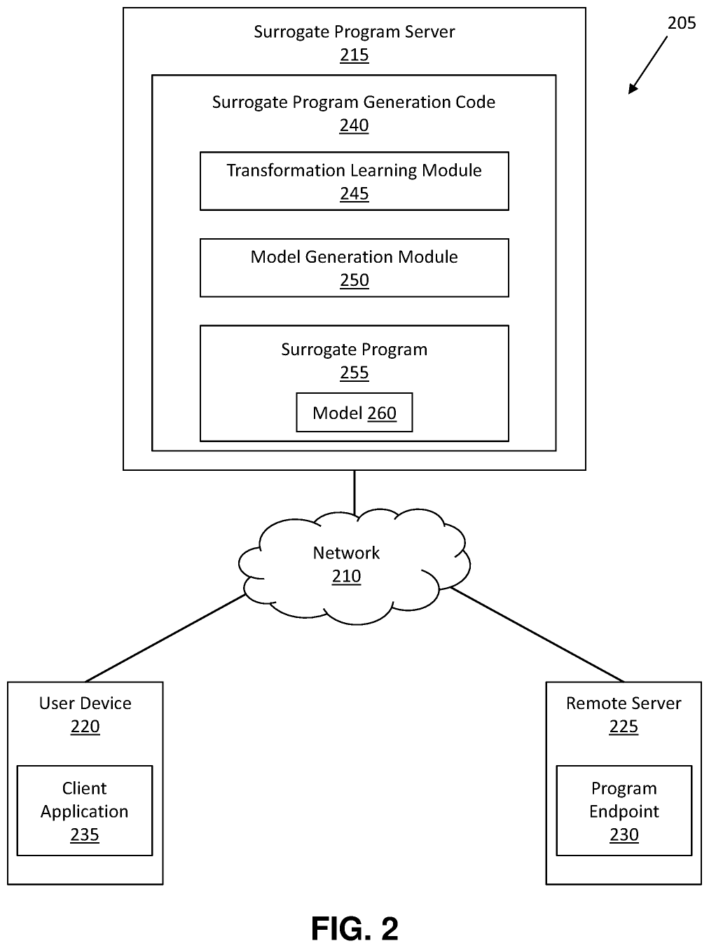

FIG. 2 shows a block diagram of an exemplary environment 205 in accordance with aspects of the invention. In embodiments, the environment 205 includes a network 210 providing communication between a surrogate program server 215, a user device 220, and a remote server 225. The network 210 may comprise any one or more communication networks such as a LAN, WAN, and the Internet, and combinations thereof. In an exemplary implementation, network 210 comprises WAN 102 of FIG. 1, surrogate program server 215 comprises computer 101 of FIG. 1, user device 220 comprises end user device 103 of FIG. 1, and remote server 225 comprises remote server 104 of FIG. 1.

In embodiments, the remote server 225 comprises a program endpoint 230 that is accessible by other computing devices (e.g., surrogate program server 215, user device 220, etc.) via the network 210, and that is configured to receive a string input and return a string output based on applying a transformation to the string input. In accordance with aspects of the invention, the code of the program endpoint 230 is not known or otherwise available to these other computing devices. In this manner, the other computing devices can provide string inputs to the program endpoint 230 and receive string outputs from the program endpoint 230, all while the source code of the program endpoint 230 is withheld from the other computing devices that are accessing the program endpoint 230. An example of a program endpoint 230 is an opaque box application programming interface (API), which is an API whose source code is withheld from computing devices that access the API. In this example, the remote server 225 may be a web server and the other computing devices may use a Uniform Resource Locator (URL) to access the program endpoint 230 (i.e., the API). Embodiments are not limited to an API; instead, other types of program endpoint 230 may be used.

In accordance with aspects of the invention, the surrogate program server 215 comprises surrogate program generation code 240 that is configured to generate a surrogate program that replicates the functionality of the program endpoint 230. In one example, the surrogate program server 215 is one or more computing devices each including one or more elements of the computer 101 of FIG. 1. In another example, the surrogate program server 215 is one or more virtual machines (VMs) or containers running on one or more computing devices. The surrogate program generation code 240 can comprise computer code (e.g., such as code represented by block 200 of FIG. 1) running on the surrogate program server 215. In embodiments, the surrogate program generation code 240 comprises a transformation learning module 245 and a model generation module 250, each of which may comprise one or more program modules that are configured to carry out the functions of embodiments of the invention. Program modules may include routines, programs, objects, components, logic, data structures, and so on that perform particular tasks or implement particular data types that the surrogate program generation code 240 uses to carry out the functions and/or methodologies of embodiments of the invention as described herein. The surrogate program server 215 may include additional or fewer programs/modules than those shown in FIG. 2. In embodiments, separate programs/modules may be integrated into a single program/module. Additionally, or alternatively, a single program/module may be implemented as multiple programs/modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

According to aspects of the invention, the transformation learning module 245 generates transformations based on a sample set of plural input/output pairs. For each respective input/output pair, the input comprises a string input that is sent to the program endpoint 230 and the output comprises a string output received from the program endpoint 230 in response to the string input. In embodiments, the transformation learning module 245 learns a transformation for each input/output pair. Some input/output pairs may have the same transformation. The transformations may be learned using one or more program synthesis algorithms, examples of which include, but are not limited to, Flash Fill and Blink Fill.

According to aspects of the invention, the model generation module 250 generates a surrogate program 255 that receives a string input and generates a string output by applying a selected one of the plural transformations to the string input. In embodiments, the surrogate program 255 comprises a model 260 that classifies the inputs of the input/output pairs to respective ones of the plural transformations, with the classification being based on parameters of the string inputs. In embodiments, the model generation module 250 generates the model 260 using decision tree learning that utilizes string inputs instead of numeric inputs.

According to aspects of the invention, the model generation module 250 refines the model 260 using active learning. In embodiments, the model 260 comprises a decision tree-based model in which the paths of the tree are interpretable and can be treated as path constraints. In the active learning phase, the model generation module 250 generates new inputs based on respective ones of the constraints in the model 260, obtains new outputs by providing the new inputs to the program endpoint 230, and refines the model 260 based on the new inputs and outputs. In embodiments, the model generation module 250 uses a satisfiability modulo theories (SMT) solver to generate the new inputs. In embodiments, refining the model 260 comprises adding a new constraint to the model.

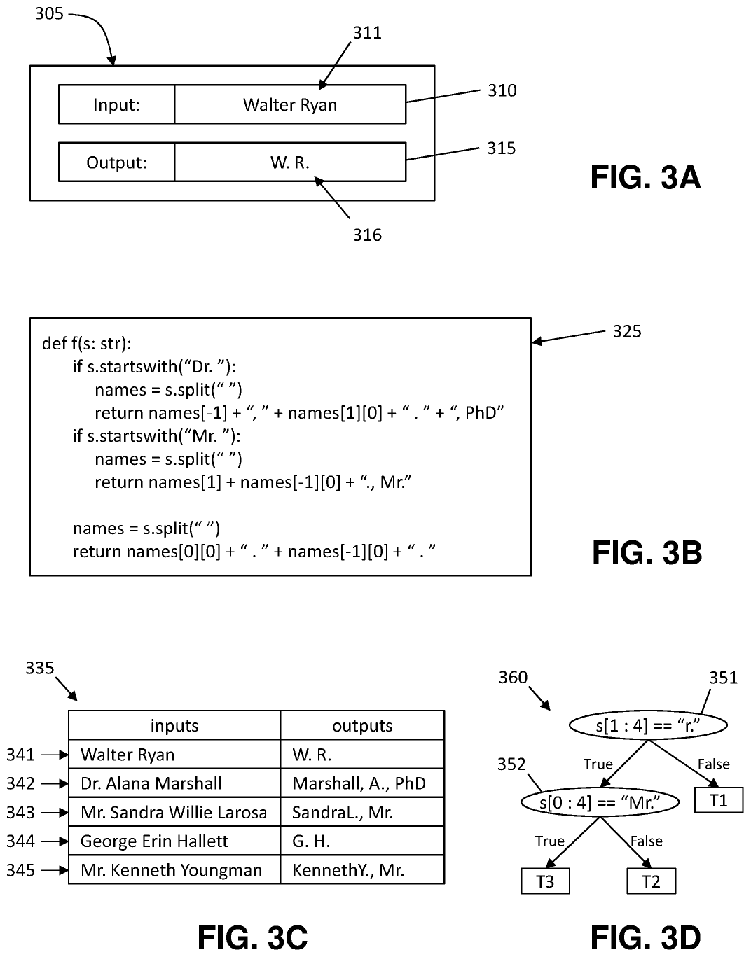

FIG. 3A shows an exemplary interface 305 of an exemplary program endpoint in accordance with aspects of the invention. The program endpoint may be the program endpoint 230 of FIG. 2, and the interface 305 may be a web interface that is accessible by a client application 235 (e.g., a browser) of the user device 220 of FIG. 2. In this example, the interface includes an input field 310 and an output field 315. In this example, a user provides a string input 311 at the input field 310. The user may be a human user or an automated user (e.g., another program). The code of the program endpoint generates a string output by applying a transformation to the string input 311 and returns the string output 316 at the output field 315.

FIG. 3B shows code 325 of the program endpoint of FIG. 3A. In accordance with aspects of the invention, the code 325 is not known to the user who provides the string input 311 at the input field 310 of the interface 305. In this manner, the program endpoint is an opaque box to the user. However, the code 325 is shown here for illustration of aspects of the invention. In this example, the code 325 utilizes “if” statements to determine which one of three different transformations to apply to the string input 311 to generate the string output 316.

FIG. 3C shows a set 335 of input/output pairs generated using the program endpoint of FIG. 3A. In this example, in the first pair 341, the program endpoint returns the output string “W. R.” in response to the input string “Walter Ryan.” In this example, in the second pair 342, the program endpoint returns the output string “Marshall, A., PhD” in response to the input string “Dr. Alana Marshall”. Third, fourth, and fifth pairs 343, 344, 345 are also shown.

FIG. 3D shows an exemplary model 360 generated in accordance with aspects of the invention, which replicates the functionality of the program endpoint. In this example, the model 360 is generated by the surrogate program generation code 240 of FIG. 2 and corresponds to the model 260 of the surrogate program 255 of FIG. 2. The model 360 comprises a decision tree that is modified for use with strings and string parameters. In this particular example, the model 360 includes a decision tree that includes two constraints 351, 352 and three transformations T1, T2, T3. In accordance with aspects of the invention, the transformation learning module 245 of the surrogate program generation code 240 (of FIG. 2) generates the transformations T1, T2, T3 using the set 335 of input/output pairs (of FIG. 3C) and transformation learning techniques such as Blink Fill. In accordance with aspects of the invention, the model generation module 250 of the surrogate program generation code 240 (of FIG. 2) determines the constraints 351, 352 and the paths by classifying the inputs of the set 335 of input/output pairs (of FIG. 3C) to the respective transformations T1, T2, T3 using path learning techniques such as decision tree learning. The model 360 is an interpretable model because it explicitly represents (e.g., shows) the constraints and paths that lead to the respective transformations T1, T2, T3.

The model 360 can be used with other inputs (i.e., different than inputs in the set 335 of input/output pairs (of FIG. 3C)) to generate outputs and, in this way, mimic the behavior of the program endpoint. For example, another input string may be input to the model 360, and the model 360 may generate another output string by applying a selected one of the transformations T1, T2, T3 to the input string.

In accordance with aspects of the invention, the system uses active learning to refine the initial model (such as the model 360, for example). In embodiments, the surrogate program generation code 240 generates plural new inputs which are different from the inputs in the set of input/output pairs used to generate the initial model. The surrogate program generation code 240 runs these inputs through both the model and the program endpoint and compares the outputs. For example, for a same input applied to both the model and the program endpoint, the surrogate program generation code 240 determines whether the output of the model matches the output of the program endpoint. In embodiments, for a particular input where the model output does not match the program endpoint output, the surrogate program generation code 240 adds an error node to the model at a location along a path that matches this particular input.

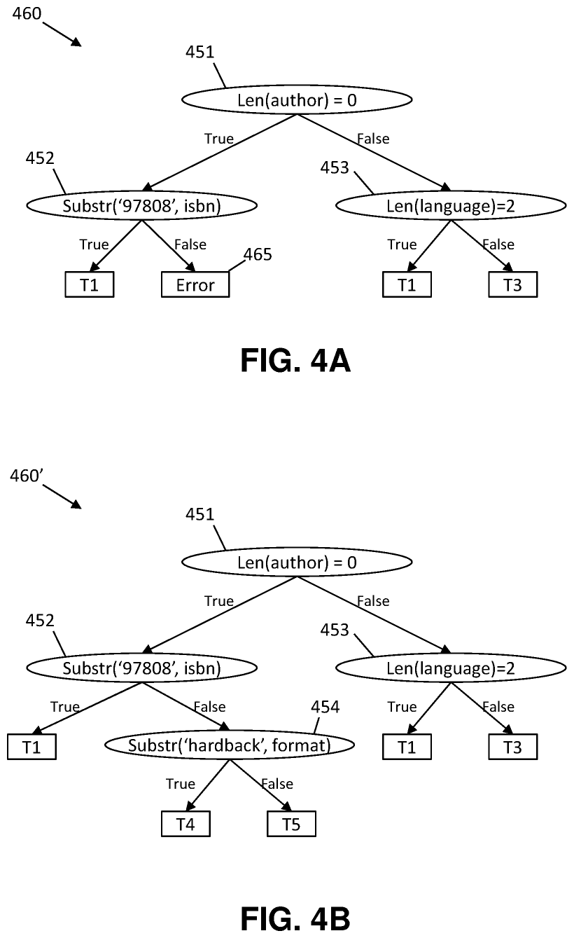

FIGS. 4A and 4B illustrate an example of refining a model using active learning in accordance with aspects of the invention. FIG. 4A shows exemplary model 460 including an error node 465. In this example, the model 460 is generated in the same manner as model 360 of FIG. 3D, but for a different program endpoint and using a different set of input/output pairs. In this example, the model 460 includes constraints 451, 452, 453 and transformations T1, T2, T3 which may be different than the constraints and transformations shown in model 360 of FIG. 3D. In this example, the surrogate program generation code 240 uses active learning to determine that the model 460 has an error node 465 at the “False” path depending from constraint 452. Continuing this example, the surrogate program generation code 240 generates plural different inputs that lead to the error node (e.g., inputs that are “True” for constraint 451 and “False” for constraint 452). In embodiments, the surrogate program generation code 240 then provides each of these inputs to the program endpoint and obtains an output for each of the inputs. In embodiments, the surrogate program generation code 240 uses this newly created set of input/output pairs with transformation learning and decision tree learning to generate a refined model 460′ as shown in FIG. 4B. In embodiments, refining the model comprises adding a new constraint to the existing model. For example, the refined model 460′ of FIG. 4B is the same as model 460 of FIG. 4A but with a new constraint 454 that replaces error node 465 and newly determined transformations T4 and T5 depending from the new constraint 454.

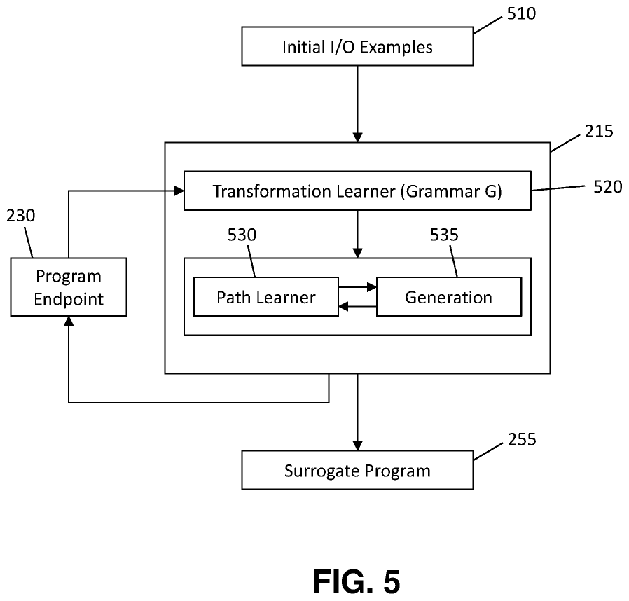

FIG. 5 shows a functional block diagram in accordance with aspects of the invention. Functions of the block diagram may be performed in the environment of FIG. 2 and are described with reference to elements depicted in FIG. 2. Initial input/output (I/O) examples 510 comprise a set of input/output pairs generated using the program endpoint 230, e.g., in the manner described herein. Block 215 corresponds to surrogate program server 215 of FIG. 2. At block 520, a transformation learner function of the surrogate program server 215 learns string transformations using the initial I/O examples 510. This may be performed by the transformation learning module 245 in the manner described herein. At block 530, a path learner function of the surrogate program server 215 employs a decision tree classifier to learn input-to-transformation mappings using the initial I/O examples 510 and the transformations learned at block 520. In embodiments, the path learner function partitions the inputs (i.e., also called samples) using constraints. At block 535, a generation function of the surrogate program server 215 provides additional inputs by solving the constraints for incremental refinement. The surrogate program server 215 provides the additional inputs to the program endpoint 230 which generates additional outputs for the additional inputs. The surrogate program server 215 then feeds the additional input/output pairs to the transformation learner block 520 for model refinement during the active learning phase. In embodiments, the active learning phase continues in this fashion until all partitions are pure (i.e., all inputs produce the same output for both the model and the program endpoint) or almost pure according to an impurity measure. In embodiments, the surrogate program server 215 then collects all root-to-leaf paths given the set of program paths and encodes the model in the surrogate program 255.

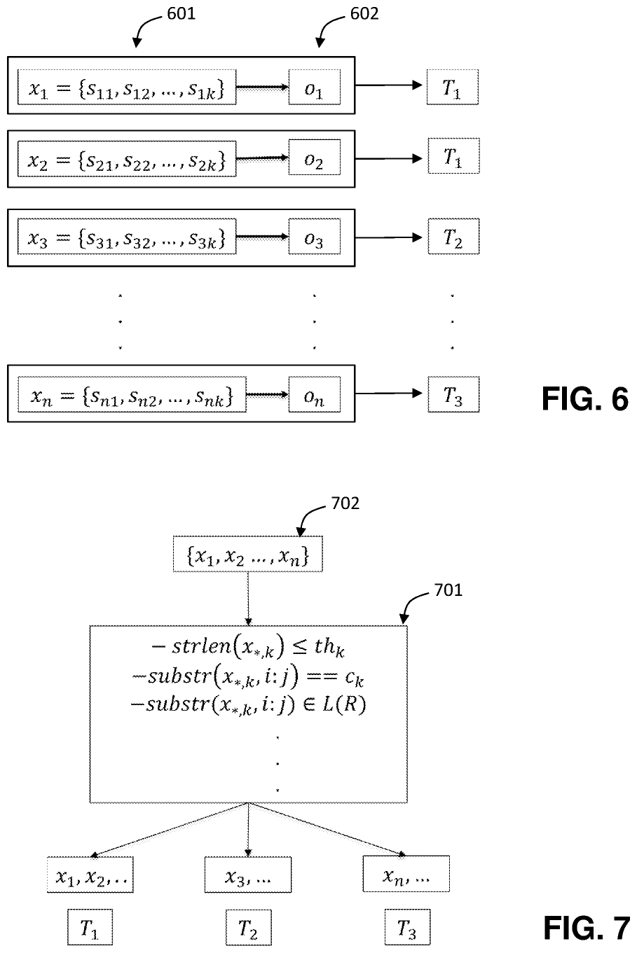

FIG. 6 shows an example of inputs, outputs, and transformations in accordance with aspects of the invention. As shown in FIG. 6, x₁, x₂, x₃, . . . , xₙ are inputs 601 to a program endpoint, and o₁, o₂, o₃, . . . , oₙ are outputs 602 generated by the program input in response to the inputs. For example, the program endpoint generates output o₁ in response to receiving input x₁, and so on. Each of the inputs x₁-xₙ comprises one or more strings sₙₖ. For example, input x₁ comprises strings s₁₁, s₁₂, . . . , s₁ₖ, and so on. A respective input and its corresponding output (e.g., x₁, o₁) constitute an input/output pair, such as one of the rows shown in FIG. 3C.

In embodiments, and as described herein, the transformation learning module (e.g., 245 of FIG. 2) learns a transformation for each input/output pair. In the example shown in FIG. 6, the transformation learning module learns transformation T₁ for input x₁, transformation T₁ for input x₂, transformation T₂ for input x₃, and transformation T₃ for input xₙ. As can be seen from inputs x₁ and x₂ of FIG. 6, some inputs may have the same learned transformation even though the inputs are different from one another.

FIG. 7 shows an example of path learning in accordance with aspects of the invention. FIG. 7 continues the example of FIG. 6, such that inputs x₁-xₙ and transformations T₁-T₃ are the same in both figures. In embodiments, and as illustrated in FIG. 7, the model generation module (e.g., 250 of FIG. 2) generates a model 701 that classifies the inputs x₁-xₙ to their learned transformations T₁-T₃ for the entire dataset 702 of inputs. In embodiments, and as described herein, the model 701 comprises a decision tree that classifies the inputs to the transformations using paths and constraints that are defined in terms of parameters of the strings s₁₁, s₁₂, . . . , s₁ₖ, of the inputs x₁-xₙ. Examples of parameters used in the constraints include string length and string content. For example, strlen(x_{*,k})≤thₖ shown in FIG. 7 is a constraint that checks whether a string (e.g., one of s₁₁, s₁₂, . . . , s₁ₖ) has a length (e.g., number of characters) less than or equal to predefined value thₖ. As another example, substr(x_{*,k}, i:j)==cₖ shown in FIG. 7 is a constraint that checks whether a substring (e.g., a sub-portion one of s₁₁, s₁₂, . . . , s₁ₖ from location i to location j) matches the predefined string cₖ. As another example, substr(x_{*,k}, i:j)∈L(R) shown in FIG. 7 is a constraint that checks whether a substring (e.g., a sub-portion one of s₁₁, s₁₂, . . . , s₁ₖ from location i to location j) matches a pattern defined by the predefined function L(R). In embodiments, these types of constraints, and other constraints based on parameters of strings of the inputs, are the constraints in the model included in the surrogate program (e.g., such as constraints 351 and 352 in model 360 of FIG. 3). This path learning can be performed for other output columns (if any) using multi-output classification.

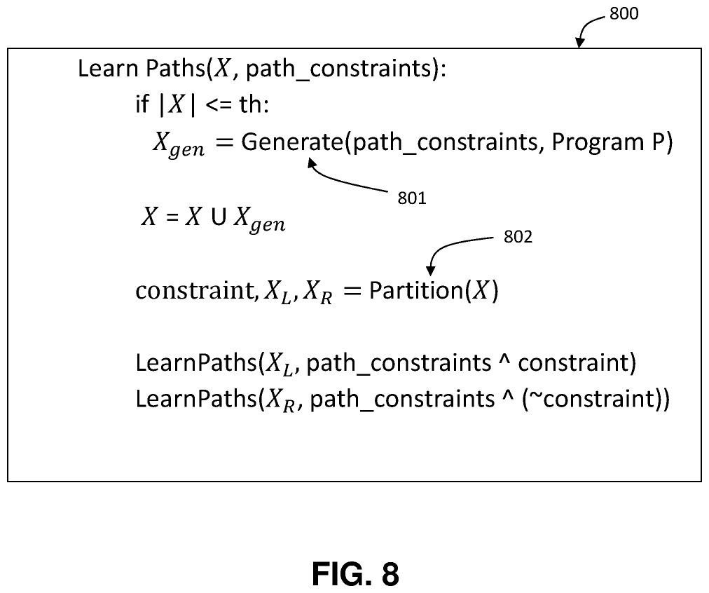

FIG. 8 shows an exemplary pseudocode 800 for a recursive path learning algorithm in accordance with aspects of the invention. In this pseudocode 800, the Generate( ) method 801 generates new samples adhering to the top path constraints so far in the path. In this pseudocode 800, the Partition( ) method 802 returns a constraint minimizing the impurity of the resulting sets. As described herein, the model generation module (e.g., 250 of FIG. 2) generates new samples (i.e., inputs) during the active learning phase. In embodiments, the model generation module generates new samples when the number of samples to partition falls below a predefined threshold. In embodiments, the model generation module also generates new samples to refine the model when the path learning arrives at a leaf and the fidelity of the leaf, as determined with randomly generated samples, is less than a predefined threshold. In embodiments, the model generation module generates new samples by passing path constraints to an SMT solver that returns samples satisfying the constraints.

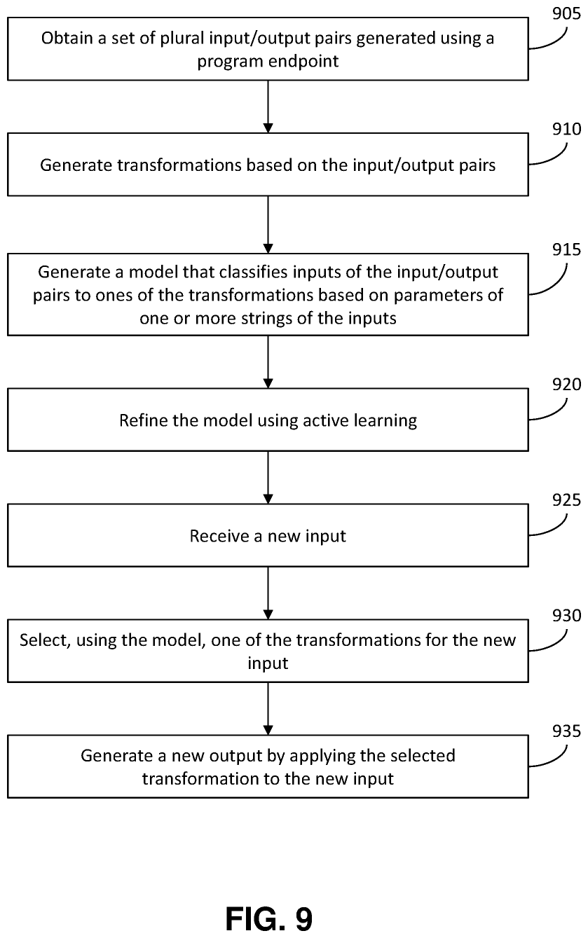

FIG. 9 shows a flowchart of an exemplary method in accordance with aspects of the present invention. Steps of the method may be carried out in the environment of FIG. 2 and are described with reference to elements depicted in FIG. 2.

At step 905, the system obtains a set of plural input/output pairs generated using a program endpoint. In embodiments, and as described herein, the surrogate program generation code 240 obtains a set of plural input/output pairs that were generated using a program endpoint 230. In embodiments, each of the input/output pairs comprises: a string input provided to the program endpoint; and a string output returned from the program endpoint in response to the string input. FIG. 3 shows an exemplary set 335 of input/output pairs. FIG. 6 shows another example of input/output pairs (x₁,o₁), (x₂,o₂), . . . , (xₙ,oₙ). In one example, the user device 220 sends the set of plural input/output pairs to the surrogate program generation code 240. In another example, the surrogate program generation code 240 retrieves the set of plural input/output pairs, e.g., from another device.

At step 910, the system generates transformations based on the input/output pairs from step 905. In embodiments, and as described herein, the transformation learning module 245 generates the transformations using transformation learning techniques such as one or more program synthesis algorithms. In embodiments, and as described at FIG. 6, the transformation learning module 245 determines a transformation for each input/output pair (from step 905). As described herein, the transformation for a particular input/output pair comprises one or more operations that produce the output of the particular input/output pair when applied to the input of the particular input/output pair.

At step 915, the system generates a model that classifies inputs of the input/output pairs to ones of the transformations (from step 910) based on parameters of one or more strings of the inputs. In embodiments, and as described herein, the model comprises an interpretable model, and the model generation module 250 generates the model using path learning techniques such as decision tree learning. In embodiments, and as described herein, the model comprises a decision tree in which nodes of the decision tree are defined in terms of parameters of one or more strings of the inputs.

At step 920, the system refines the model using active learning. In embodiments, and as described herein, the active learning comprises generating additional inputs that satisfy one or more constraints of the model, obtaining additional outputs by providing the additional inputs to the program endpoint, and feeding the resulting additional input/output pairs back into the transformation learning and path learning algorithms. Based on this, the model generation module 250 refines the model by adding a new constraint to the model. In embodiments, and as described herein, the additional inputs are generated using an SMT solver.

At step 925, the system receives a new input. For example, a user utilizing the user device 220 may specify a new input string. At step 930, the system selects, using the model, one of the transformations based on parameters of one or more strings of the new input. In embodiments, step 930 comprises using the model to classify the new input to one of the determined transformations, the classifying being based on whether parameters of strings of the new input satisfy constraints at nodes of the model. At step 935, the system generates a new output by applying the selected one of the transformations (from step 930) to the new input (from step 925). Step 935 may include returning the generated new output to the device that provided the new input. Implementations of steps 925, 930, and 935 may constitute a method of using the model as a surrogate for the program endpoint.

As should be understood from the description herein, implementations of the invention may be used as a system for learning a program surrogate assuming opaque box access at the program endpoint and initial input/output examples. Surrogate learning can exploit the availability of a target program for active querying. Implementations include a method to incrementally learn such surrogates for programs having string input/outputs, with refinement. Embodiments use a set of constraints to partition string inputs. These constraints may be solved using an SMT solver to generate more samples. Embodiments also use a generation strategy to guide the path learner towards regions (in the input space) where the program and current surrogate disagree.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of providing a surrogate program for a program endpoint, comprising:
obtaining, by a processor set, a set of plural input/output pairs generated using the program endpoint;
generating, by the processor set, transformations based on the input/output pairs;
generating, by the processor set, a model that classifies inputs of the input/output pairs to ones of the transformations based on parameters of one or more strings of the inputs;
receiving, by the processor set, a new input;
selecting, by the processor set and using the model, one of the transformations based on parameters of one or more strings of the new input; and
generating, by the processor set, a new output by applying the selected one of the transformations to the new input.

2. The method of claim 1, wherein each of the input/output pairs comprises:
a string input provided to the program endpoint; and
a string output returned from the program endpoint in response to the string input.

3. The method of claim 1, wherein the processor set performs the generating the transformations and the generating the model without knowledge of source code of the program endpoint.

4. The method of claim 1, wherein the program endpoint comprises an application programming interface (API) endpoint that receives a string input and returns a string output.

5. The method of claim 1, wherein the model comprises an interpretable model.

6. The method of claim 1, wherein the generating the model comprises using decision tree learning.

7. The method of claim 1, further comprising refining the model using active learning with the program endpoint.

8. The method of claim 7, wherein the active learning comprises:
generating additional inputs;
obtaining additional outputs from the program endpoint using the additional inputs; and
changing the model based on the additional inputs and the additional outputs.

9. The method of claim 8, wherein:
the additional inputs satisfy a constraint in the model; and
the changing the model comprises adding a new constraint to the model.

10. The method of claim 9, wherein the generating the additional inputs comprises using a satisfiability modulo theories solver.

11. A computer program product comprising one or more computer readable storage media having program instructions collectively stored on the one or more computer readable storage media, the program instructions executable to:
obtain a set of plural input/output pairs generated using a program endpoint;
generate transformations based on the input/output pairs;
generate a model that classifies inputs of the input/output pairs to ones of the transformations, wherein the model comprises an interpretable model;
receive a new input;
select, using the model, one of the transformations based on parameters of one or more strings of the new input; and
generate a new output by applying the selected one of the transformations to the new input.

12. The computer program product of claim 11, wherein each of the input/output pairs comprises:
a string input provided to the program endpoint; and
a string output returned from the program endpoint in response to the string input.

13. The computer program product of claim 11, wherein the program endpoint comprises an application programming interface (API) endpoint that receives a string input and returns a string output.

14. The computer program product of claim 11, further comprising:
generating additional inputs;
obtaining additional outputs from the program endpoint using the additional inputs; and
refining the model based on the additional inputs and the additional outputs.

15. The computer program product of claim 14, wherein:
the additional inputs satisfy a constraint in the model; and
the refining the model comprises adding a new constraint to the model.

16. A system comprising:
a processor set, one or more computer readable storage media, and program instructions collectively stored on the one or more computer readable storage media, the program instructions executable to:
obtain a set of plural input/output pairs generated using a program endpoint;
generate transformations based on the input/output pairs;
generate a model that classifies inputs of the input/output pairs to ones of the transformations, wherein the model comprises an interpretable model;
receive a new input;
select, using the model, one of the transformations based on parameters of one or more strings of the new input; and
generate a new output by applying the selected one of the transformations to the new input.

17. The system of claim 16, wherein each of the input/output pairs comprises:
a string input provided to the program endpoint; and
a string output returned from the program endpoint in response to the string input.

18. The system of claim 16, wherein the program endpoint comprises an application programming interface (API) endpoint that receives a string input and returns a string output.

19. The system of claim 16, further comprising:
generating additional inputs;
obtaining additional outputs from the program endpoint using the additional inputs; and
refining the model based on the additional inputs and the additional outputs.

20. The system of claim 19, wherein:
the additional inputs satisfy a constraint in the model; and
the refining the model comprises adding a new constraint to the model.
